(19) United States
(12) Patent Application Publication
(10) Pub. No.: US 2004/0026227 A1
(43) Pub. Date: Feb. 12, 2004

(54) Separator system

(76) Inventor: Mark John LaCour, Katy, TX (US)

Correspondence Address: PHILLIPS PETROLEUM COMPANY, BEVERLY M. DOLLAR, 202 PATENT & LIBRARY BLDG., PRC, BARTLESVILLE, OK, 74004, US

(21) Appl. No.: 09/804,962

(22) Filed: Mar. 13, 2001

(51) Int. Cl. B01D 3/00

(52) U.S. Cl. 203/71; 202/232

(57) ABSTRACT

An improved system for reboiling a liquid in a separator is disclosed. The system includes a separator having a bottom fractionation tray, a conduit for removing liquid accumulated on the bottom fractionation tray, and a reboiler for reboiling liquid removed from the bottom fractionation tray to form a vapor which is returned to the separator by another conduit and below the spatial location of the bottom tray. The vapor returned to the separator is at least substantially sealed off from fluid flow communication with the accumulated liquid removed from the bottom fractionation tray.

The present invention relates to an apparatus and process for separating liquids. More specifically, the invention relates to an apparatus and process for reboiling liquid collected in the bottom of a separator.

### BACKGROUND OF THE INVENTION

The process of separating liquids in a separator having fractionation trays is well known in the art. In some separator configurations, the liquid head to a reboiler reboiling liquid removed from the bottom of the separator can be critical, especially when thermosiphon reboilers are used, wherein pumping systems are not used. In such cases, the liquid head is preferably high, so as to provide sufficient motive force to the reboiler inlet liquid. However, the return vapor line in such separators preferably returns vapor to the separator at a spatial location below the lowest fractionation tray, so that the vapor can pass up through the lowest tray and contact the liquid accumulating thereon. To keep from flooding the vapor return line, which would disrupt the distribution of vapor to the lowest fractionation tray, industry practice is to keep the liquid level in the bottom of the separator below the level of the vapor return line. As a result, the liquid head to the reboiler is constrained to a level below the spatial location of the vapor return line.

Thus, it is desirable to have an apparatus and system for separating liquids wherein the liquid head to the reboiler is not constrained by the spatial location of the vapor return line.

### SUMMARY OF THE INVENTION

It is an object of the present invention to provide an apparatus to be used in the separation of liquids in a more efficient manner.

It is a further object of the present invention to provide a method of separating liquids in a more efficient manner.

It is another object of the present invention to provide an apparatus to be used in reboiling a liquid in a more efficient manner.

It is a yet further object of the present invention to provide a method of reboiling a liquid in a more efficient manner.

In accordance with a first embodiment of the present invention, the separator includes:

a vessel having an inside wall;

at least one fractionation tray disposed within the vessel, the at least one fractionation tray including a bottom tray;

vapor delivery means operably related in fluid flow communication with the vessel for delivering vapor to the vessel at a spatial location below the bottom tray; and

liquid removal means operably related in fluid flow communication with the bottom tray and the vessel for removing accumulated liquid on the bottom tray from the vessel.

In accordance with a second embodiment of the present invention, a process for reboiling liquid in a separator includes:

accumulating a liquid on a bottom tray of a separator;

overflowing liquid from the bottom tray into at least one downcomer thereby forming an overflow liquid stream;

removing the overflow liquid stream from the at least one downcomer and the separator;

heating at least a portion of the overflow liquid stream thereby forming a vapor; and

introducing the vapor into the separator at a spatial location below the bottom tray.

In accordance with a third embodiment of the present invention, a process for maximizing the liquid head to a reboiler of a separator includes:

accumulating a liquid on a bottom tray of a separator;

overflowing at least a portion of the liquid from the bottom tray into at least one downcomer thereby forming an overflow liquid stream;

passing the overflow liquid stream from the at least one downcomer to reboiler means;

vaporizing at least a portion of the overflow liquid stream in the reboiler means thereby forming a vapor;

passing the vapor from the reboiler means to the separator at a spatial location below the bottom tray; and

wherein the liquid head of the overflow liquid stream to the reboiler means is in the range of from the level of the reboiler means up to the level where the liquid overflows from the bottom tray into the at least one downcomer.

### BRIEF DESCRIPTION OF THE DRAWINGS

FIG. 1 is a cross sectional view of the lower end of a separator constructed in accordance with the present invention.

FIG. 2 is an expanded view showing passageway 128 in more detail.

FIG. 3 is a section taken across line A-A of the separator of FIG. 1.

FIG. 4 is a section taken across line B-B of the separator of FIG. 1.

### DETAILED DESCRIPTION OF THE INVENTION

The apparatus and process of the present invention will be described with reference to the drawings. Reference to the specific configurations of the drawings is not meant to limit the invention to the details of the drawings disclosed in conjunction therewith.

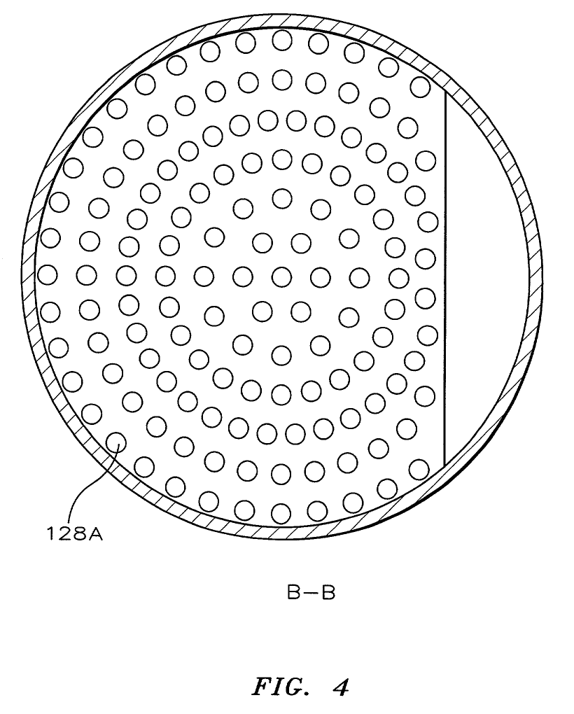

Regarding the first embodiment of the present invention, and referring to FIGS. 1, 2, 3, and 4 therein is illustrated the inventive separator 10 comprising, consisting of, or consisting essentially of, a vessel 100 having an inside wall 102, a first opening 104, and a second opening 105 in inside wall 102; at least one fractionation tray disposed within vessel 100, including a bottom tray 106; vapor delivery means 108 operably related in fluid flow communication with vessel 100 for delivering vapor to vessel 100 at a spatial location below bottom tray 106; and liquid removal means 110 operably related in fluid flow communication with bottom tray 106 and vessel 100 for removing accumulated liquid on bottom tray 106 from vessel 100.

Vapor delivery means 108 can include any suitable conveyance device capable of conveying a fluid, such as, but not limited to, a conduit, pipe or a sparger, and equivalents thereof. When vapor delivery means 108 is a conduit, the vapor delivery means 108 has a first outside surface 112, a first open end 114 which opens within vessel 100 below bottom tray 106, and a second open end 116. Second open end 116 extends through second opening 105 in inside wall 102 of vessel 100, wherein first outside surface 112 is in sealing engagement with second opening 105.

Bottom tray 106 can be further characterized to include a top surface 118 and at least one downcomer 120 extending downwardly from top surface 118 for removal of accumulated liquid from bottom tray 106. Bottom tray 106 can have a downcomer 120 on each side of vessel 100, or can have as many downcomers, and in any configuration, as are necessary for efficient separator operation.

Liquid removal means 110 can include any suitable conveyance device capable of conveying a fluid, such as, but not limited to, a conduit, a pipe or a sparger, and equivalents thereof. When liquid removal means 110 is a conduit, liquid removal means 110 has a second outside surface 122, a third open end 124 and a fourth open end 126. Third open end 124 is connected in fluid flow communication with downcomer 120 and fourth open end 126 extends through first opening 104 in inside wall 102 of vessel 100, wherein second outside surface 122 is in sealing engagement with first opening 104.

Preferably, downcomer 120 and liquid removal means 110 are sealed off, at least substantially, from fluid flow communication with vapor delivery means 108. “Substantially” meaning that less than 1% of the liquid from downcomer 120 and/or liquid removal means 110 can mix with the vapor in the vapor delivery means 108 and/or, that less than 1% of the vapor in vapor delivery means 108 can mix with the liquid in downcomer 120 and/or liquid removal means 110.

Bottom tray 106 can further comprise passageways 128 up through which vapor can pass. Preferably, passageways 128 are configured such that liquid accumulated on bottom tray 106 does not, at least substantially does not, pass through passageways 128. “Substantially” meaning that less than 1% of the liquid accumulated on bottom tray 106 can pass through passageways 128.

Passageways 128 in the bottom tray 106 can be of any configuration capable of allowing vapor to pass up through the bottom tray 106 and substantially keeping liquid from passing down through bottom tray 106.

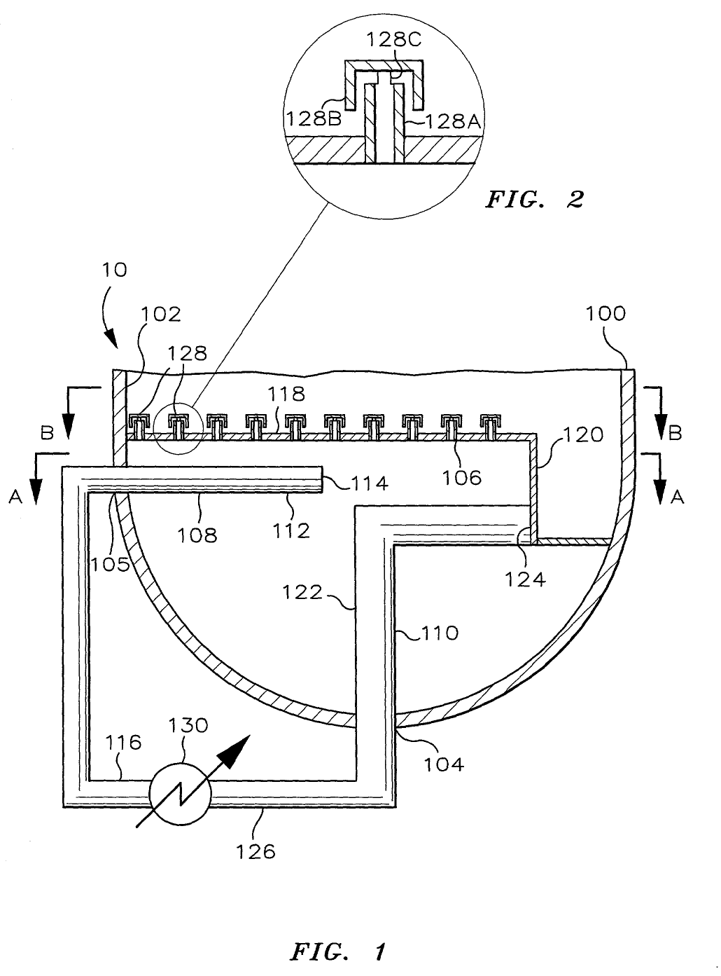

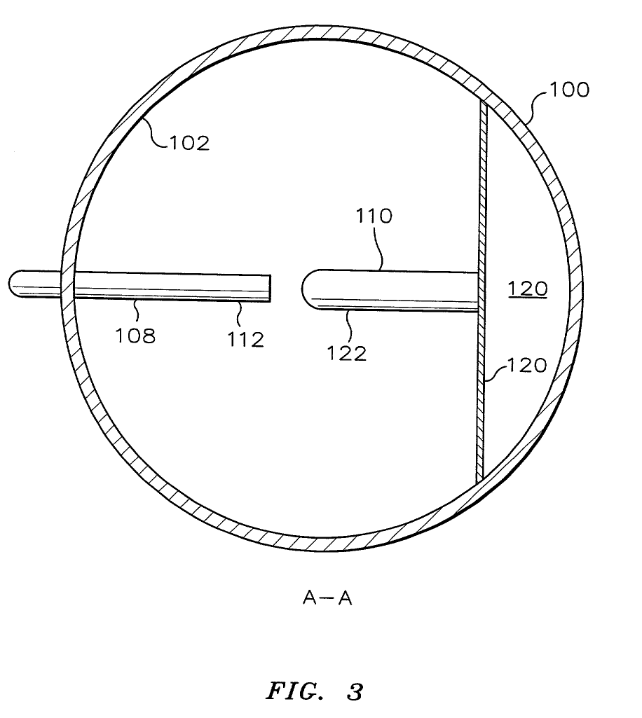

In one embodiment, and referring to FIG. 2, each passageway 128 can comprise a cylindrical portion 128A fixedly secured to bottom tray 106, providing for fluid flow communication between the zones above and below bottom tray 106; and a chimney hat 128B fixedly secured to cylindrical portion 128A via at least one tab 128C, wherein chimney hat 128B also provides for fluid flow communication between the zones above and below bottom tray 106.

Separator 10 can also include reboiler means 130 operably connected in fluid flow communication with vapor delivery means 108 and with liquid removal means 110 for reboiling accumulated liquid removed from bottom tray 106 by liquid removal means 110 to form vapor for delivery to vessel 100 through vapor delivery means 108.

Liquid removal means 110 is preferably configured in order to provide accumulated liquid to reboiler means 130 at a liquid head which extends vertically to a level in the range of from reboiler means 130 inlet up to the level of the top surface 118 of bottom tray 106.

Reboiler means 130 can be any suitable reboiler capable of receiving a liquid from a vessel and at least partially vaporizing the liquid to form a vapor for return of the vapor to the vessel. More particularly, reboiler means 130 can be of a type including a thermosiphon (vertical or horizontal), kettle, forced recirculation, and any equivalents thereof. The most preferred reboiler means for the present invention is a thermosiphon type reboiler.

When reboiler means 130 is a thermosiphon type, the liquid head of the accumulated liquid in liquid removal means 110 preferably provides for natural circulation of the accumulated liquid from vessel 100 to reboiler means 130 and back to vessel 100 as vapor.

In accordance with a second embodiment of the present invention, and referring to FIG. 1 and the reboiling of liquid in separator 10, as described in the first embodiment, a liquid is accumulated on top surface 118 of bottom tray 106 of vessel 100. The accumulated liquid is allowed to overflow from top surface 118 of bottom tray 106 into downcomer 120 of bottom tray 106 thereby forming an overflow liquid stream. Preferably, substantially all of the liquid overflowing from the top surface 118 of bottom tray 106 is collected in downcomer 120, and more preferably, all of the liquid overflowing from top surface 118 is collected in downcomer 120. “Substantially” meaning that at least 99% of the liquid overflowing from top surface 118 of bottom tray 106 is collected in downcomer 120.

The overflow liquid stream is removed from downcomer 120 and vessel 100, preferably by liquid removal means 110. At least a portion of the overflow liquid stream is heated, preferably in reboiler means 130, thereby forming a vapor. The vapor is introduced into vessel 100 at a spatial location below bottom tray 106, preferably through vapor delivery means 108.

The vapor introduced to vessel 100 passes up through passageways 128 in bottom tray 106, and the liquid accumulated on bottom tray 106 is preferably substantially, and is more preferably completely, kept from passing down through passageways 128, as described above. The vapor introduced into vessel 100 is also preferably sealed off from fluid flow communication with the overflow liquid stream, as described above.

In addition, the liquid level (liquid head) of the overflow liquid stream supplied to reboiler means 130 preferably can be above the spatial location where the vapor is introduced into vessel 100.

In accordance with a third embodiment of the present invention regarding a process for maximizing the liquid head to reboiler means, and referring to FIG. 1, such process includes the process described in the second embodiment and further includes that the liquid head of the overflow liquid stream to reboiler means 130 is in the range of from the level of reboiler means 130 up to the level where the accumulated liquid overflows from top surface 118 of bottom tray 106 into downcomer 120 of bottom tray 106. Preferably, the liquid head of the overflow liquid stream provides for natural circulation of the overflow liquid stream from vessel 100 to reboiler means 130 and back to vessel 100 as vapor. Reboiler means 130 preferably uses steam to heat the overflow liquid stream.

Whereas this invention has been described in terms of the preferred embodiments, reasonable variations and modifications are possible by those skilled in the art. Such variations and modifications are within the scope of the described invention and appended claims.

That which is claimed is:

1. A separator comprising:
a vessel having an inside wall;
at least one fractionation tray disposed within said vessel, said at least one fractionation tray including a bottom tray;
vapor delivery means operably related in fluid flow communication with said vessel for delivering vapor to said vessel at a spatial location below said bottom tray; and
liquid removal means operably related in fluid flow communication with said bottom tray and said vessel for removing accumulated liquid on said bottom tray from said vessel.

2. A separator in accordance with claim 1 wherein said vapor delivery means comprises a conduit having an outside surface, a first open end and a second open end, wherein said first open end opens within said vessel below said bottom tray and wherein said second open end extends through an opening in said inside wall of said vessel, said outside surface of said conduit being in sealing engagement with said opening in said inside wall of said vessel.

3. A separator in accordance with claim 1 wherein said bottom tray is further characterized to include a top surface and at least one downcomer extending downwardly from said top surface for removal of said accumulated liquid from said bottom tray; and
wherein said liquid removal means comprises a conduit having an outside surface, a first end and a second end, wherein said first end is connected in fluid flow communication with said at least one downcomer and said second end extends through an opening in said inside wall of said vessel, said outside surface of said conduit being in sealing engagement with said opening in said inside wall of said vessel.

4. A separator in accordance with claim 3 wherein said at least one downcomer and said conduit are substantially sealed off from fluid flow communication with said vapor delivery means.

5. A separator in accordance with claim 1 wherein said bottom tray further comprises passageways, wherein said vapor passes up through said passageways, and wherein said liquid accumulated on said bottom tray substantially does not pass through said passageways.

6. A separator in accordance with claim 1 wherein said vapor delivery means is substantially sealed off from fluid flow communication with said liquid removal means.

7. A separator in accordance with claim 1 further characterized to include reboiler means operably connected in fluid flow communication with said vapor delivery means and with said liquid removal means for reboiling said accumulated liquid removed from said bottom tray by said liquid removal means to form said vapor for delivery to said vessel through said vapor delivery means.

8. A separator in accordance with claim 7 wherein said liquid removal means is configured in order to provide said accumulated liquid to said reboiler means at a liquid head which extends vertically to a level in the range of from said reboiler means inlet up to the level of said bottom tray.

9. A separator in accordance with claim 7 wherein said reboiler means is a thermosiphon type reboiler.

10. A separator in accordance with claim 9 wherein said liquid head of said accumulated liquid provides for natural circulation of said accumulated liquid from said separator to said reboiler means and back to said separator as said vapor.

11. A process for reboiling liquid in a separator comprising:
accumulating a liquid on a bottom tray of said separator;
overflowing said liquid from said bottom tray into at least one downcomer thereby forming an overflow liquid stream;
removing said overflow liquid stream from said at least one downcomer and said separator;
heating at least a portion of said overflow liquid stream thereby forming a vapor; and
introducing said vapor into said separator at a spatial location below said bottom tray.

12. A process in accordance with claim 11 wherein substantially all of said liquid overflowing from said bottom tray is collected in said at least one downcomer.

13. A process in accordance with claim 11 wherein all of said liquid overflowing from said bottom tray is collected in said at least one downcomer.

14. A process in accordance with claim 11 wherein said vapor passes up through passageways in said bottom tray, and wherein said liquid accumulated on said bottom tray is substantially kept from passing down through said passageways.

15. A process in accordance with claim 11 wherein said overflow liquid stream is substantially sealed off from fluid flow communication with said vapor introduced into said separator.

16. A process in accordance with claim 11 wherein said heating of said at least a portion of said overflow liquid stream is in reboiler means for reboiling liquid, and wherein the liquid level in said downcomer supplying said overflow liquid stream to said reboiler means is above said spatial location where said vapor is introduced into said separator.

17. A process for maximizing the liquid head to reboiler means for reboiling liquid of a separator comprising:
accumulating a liquid on a bottom tray of said separator;
overflowing at least a portion of said liquid from said bottom tray into at least one downcomer thereby forming an overflow liquid stream;
passing said overflow liquid stream from said at least one downcomer to said reboiler means;
vaporizing at least a portion of said overflow liquid stream in said reboiler means thereby forming a vapor;
passing said vapor from said reboiler means to said separator at a spatial location below said bottom tray; and
wherein the liquid head of said overflow liquid stream to said reboiler means is in the range of from the level of the reboiler means up to the level where said liquid overflows from said bottom tray into said at least one downcomer.

18. A process in accordance with claim 17 wherein substantially all of said liquid overflowing from said bottom tray is collected in said at least one downcomer.

19. A process in accordance with claim 17 wherein all of said liquid overflowing from said bottom tray is collected in said at least one downcomer.

20. A process in accordance with claim 17 wherein said vapor passes up through passageways in said bottom tray, and wherein said liquid accumulated on said bottom tray is substantially kept from passing down through said passageways.

21. A process in accordance with claim 17 wherein said overflow liquid stream is substantially sealed off from fluid flow communication with said vapor passed from said reboiler means to said separator.

22. A process in accordance with claim 17 wherein said reboiler means uses steam to heat said overflow liquid stream.

23. A process in accordance with claim 22 wherein said reboiler means is a thermosiphon type reboiler.

24. A process in accordance with claim 23 wherein said liquid head of said overflow liquid stream provides for natural circulation of said overflow liquid stream from said separator to said reboiler means and back to said separator as said vapor.
